(19) United States
(12) Patent Application Publication
(10) Pub. No.: US 2023/0133561 A1
(43) Pub. Date: May 4, 2023

(54) GRIPPER

(71) Applicant: COMMISSARIAT A L'ENERGIE ATOMIQUE ET AUX ENERGIES ALTERNATIVES, Paris (FR)

(72) Inventors: Fares KFOURY, Gif Sur Yvette Cedex (FR); Mathieu GROSSARD, Gif Sur Yvette Cedex (FR)

(73) Assignee: COMMISSARIAT A L'ENERGIE ATOMIQUE ET AUX ENERGIES ALTERNATIVES, Paris (FR)

(21) Appl. No.: 18/052,281

(22) Filed: Nov. 3, 2022

(30) Foreign Application Priority Data
Nov. 4, 2021 (FR) 21 11736

(51) Int. Cl. B25J 15/00; B25J 15/02

(52) U.S. Cl. CPC B25J 15/0009; B25J 15/0213; B25J 15/022

(57) ABSTRACT

A gripper including a frame and a finger including a first distal phalanx and a second proximal phalanx mechanically linked, the second phalanx includes a first bar and a linear actuator arranged so as to form a first four-bar linkage. A gripping device including a plurality of grippers.

The present invention relates to the handling field and more particularly the gripping field.

### BACKGROUND OF THE INVENTION

Conventionally, a gripper comprises a clamp including a frame on which a proximal end of an actuated finger is articulated. The distal end of the finger comprises a jaw generally provided with an anti-slip surface. In general, the finger is rectilinear or curved. Such a clamp is particularly suitable for grasping objects with a similar and ideally predefined geometry. Such a clamp lacks versatility, particularly for grasping special objects such as objects that are large-sized, planar, or having a cylindrical or conical portion. It is then necessary to replace the clamp with a tool that is suitable for such special objects.

In order to improve the versatility of a gripper, it has been considered to make a clamp comprising two articulated phalanxes. In general, such a gripper comprises a finger composed by a distal first phalanx and a proximal second phalanx articulated on a frame and articulated together so as to enable a rotation of the first phalanx relative to the second phalanx so that the finger could switch from an opening configuration into a clamping configuration. A first actuator controls the movement of the first phalanx and a second actuator controls the movement of the second phalanx. In general, the motors and the reducers associated with the actuators are attached on the frame and the transmission is carried by the phalanxes. Control of the clamping force applied by such a finger requires equipping all of the actuators and the articulations with instrumentation. Such instrumentation is heavy, costly and the cumulated drift of all of the measuring instruments added to the frictions of the transmission does not allow for an accurate control of clamping of the gripper suited to handling of delicate objects. Finally, the inertia of such a gripper is also detrimental to the accuracy of the control of the clamping force.

### OBJECT OF THE INVENTION

In particular, the invention aims to improve the accuracy of control of a clamping force of a gripper with fingers.

### SUMMARY OF THE INVENTION

To this end, a gripper is provided including a frame and an actuated finger, the finger comprising a first distal phalanx and a second proximal phalanx which is articulated on the frame about a first axis, the first phalanx and the second phalanx being mechanically linked so as to enable a rotation of the first phalanx about a second axis substantially parallel to the first axis so that the finger could switch from an opening configuration into a clamping configuration when the first phalanx and/or the second phalanx performs a rotation in a first way relative to the frame. According to the invention, the second phalanx comprises a first bar comprising a first end linked to the first phalanx and a second end pivotally mounted on the frame about the first axis. The second phalanx also comprises a linear actuator comprising a third end linked to the first phalanx and a fourth end pivotally mounted on the frame, the first bar and the linear actuator being arranged so as to form a first four-bar linkage wherein a distance separating the third end from the fourth end can be modified.

This difference from four-bar linkages known in such applications wherein the distance that separates the articulation points of the bars is fixed contributes to the obtainment of a gripper that is lighter and in which the transmission of movement to the first phalanx has a reduced inertia of the gripper. The gripper of the invention is more transparent and has an improved reversibility of the actuation which allows for an accurate return and a control of the force by direct measurement of the motor current.

The presence of a force sensor at the actuator becomes useless.

The versatility of the gripper is improved when the finger comprises a third phalanx linking the first phalanx and the second phalanx.

The compactness of the gripper is improved when the third phalanx comprises a second bar comprising a fifth end articulated on the first phalanx and a six end articulated on a first connecting rod, the third phalanx also comprising a third bar comprising a seventh end articulated on the first phalanx and an eighth end articulated on the first connecting rod, the first end and the third end being articulated with the first connecting rod.

The compactness of the gripper is improved even further when an orthogonal projection of the third end on a line connecting the first end and the eighth end belongs to a section connecting the first end and the eighth end.

The compactness of the gripper is improved even further when the first end is articulated on the sixth end.

Advantageously, the second phalanx comprises a first member for biasing the finger towards the opening configuration and/or the third phalanx comprises a second member for biasing the finger towards the opening configuration. An economic embodiment is obtained when the biasing member comprises an elastic element.

The mass of the gripper and its inertia are improved when the linear actuator comprises a screw jack cylinder, preferably a cylinder comprising a ball screw.

The hyperstaticity of the mechanism is reduced when the linear actuator is linked to the finger and/or to the chassis by a sliding pivot type connection with a limited sliding with a third axis substantially parallel to the first axis.

The accuracy of the gripper is improved when the gripper comprises at least one rotary encoder.

The versatility of the gripper is improved when the finger comprises a controllable adhesive element.

A sensitive improvement of the versatility of the gripper is obtained when the adhesive element is arranged so as to exert a holding force according to a direction substantially orthogonal to the first axis.

Advantageously, the adhesive element is secured to the first phalanx.

The gripper enables handling of objects that cannot be gripped—such as planar objects—when the gripper comprises a first stop to limit a first angular stroke of a first rotation of the first phalanx about the second axis in a second way opposite to the first way. Optionally, the first angular stroke comprises a first angular sector strictly positive according to the second way and measured starting from a first plane comprising the first axis and the second axis.

Advantageously, the angular sector is comprised between ten and ninety degrees, preferably comprised between twenty and sixty degrees.

Still advantageously, the gripper comprises a third biasing member of the first phalanx for exerting a third biasing force which brings the first phalanx from a position located in the first angular sector towards a position leading to the opening configuration of the finger.

The gripper can be easily adapted when the third biasing member comprises means for setting an over-opening position of the first phalanx starting from which the third biasing force is exerted.

A simple design is obtained when the third biasing member comprises a spring and the means for adjusting the over-opening position comprise a cable with an adjustable length linked to one end of the spring.

The invention also relates to a gripping device which comprises a plurality of grippers of the above-described type or of an already known type.

According to other non-exclusive and optional particular embodiments of the invention:
the plurality of grippers comprises a first gripper, a second gripper and a third gripper;
the first gripper and the second gripper are respectively carried by a first plate and a second plate slidably mounted relative to the chassis according to two opposite ways of a first direction;
the sliding movements of the first plate and of the second plate are actuated using a first actuation device provided with a unique second actuator.
the second actuator is a rotary actuator and/or the first plate comprises a second screw/nut set and/or the second plate comprises a third screw/nut set.
the first actuation device comprises a first pinion for driving a first transmission member with a drive force;
the first gripper comprising a first actuated finger, the second gripper comprising a second actuated finger, the first actuated finger is articulated relative to the first plate about a fifth axis and the second actuated finger is articulated relative to the second plate about a sixth axis, the fifth axis and the sixth axis being substantially orthogonal to the first axis;
a rotation of the first finger relative to the first plate about the fifth axis (O5) and a rotation of the second finger (123) about the sixth axis (O6) are actuated using a second actuation device.
the second actuation device is provided with a unique third actuator;
the second actuation device is arranged so that a sliding movement of the first plate and/or of the second plate is decoupled from a rotational movement of the first actuated finger and of the second actuated finger and vice versa;
the second actuation device is arranged so that the rotational movements of the first finger and of the second finger are performed in opposite rotational ways;
the third actuator is a rotary actuator secured to the first plate;
the second actuation device comprises a second pinion for driving a second transmission member with a drive force;
the second transmission member forming a closed loop, the second actuation device comprises a first idler of second transmission member and a second idler member of a second transmission member, the first idler and the second idler being secured to the chassis;
the second transmission member is a belt that is toothed over both faces thereof;
the plurality of grippers comprises a fourth gripper;
the third gripper and the fourth gripper are respectively carried by a third plate and a fourth plate slidably mounted relative to the chassis according to two opposite ways of a second direction;
the sliding movements of the third plate and of the fourth plate are actuated using a third actuation device provided with a unique fourth actuator;
the fourth actuator is a rotary actuator and/or the third plate comprises a fourth screw/nut set and/or the fourth plate comprises a fifth screw/nut set and/or the third actuation device comprises a third pinion for driving a third transmission member with a drive force;
the third gripper comprising a third actuated finger and the fourth gripper comprising a fourth actuated finger, the third actuated finger is articulated relative to the third plate about a seventh axis and the fourth actuated finger is articulated relative to the fourth plate about an eighth axis, the seventh axis and the eighth axis being substantially orthogonal to the first axis;
a rotation of the third finger relative to the frame about the seventh axis and a rotation of the fourth finger about the eighth axis are actuated using a fourth actuation device arranged so that the rotational movements of the third finger and of the fourth finger being performed in opposite rotational ways;
the fourth actuation device is arranged so that a sliding movement of the third plate and/or the fourth plate is decoupled from a rotational movement of the third actuated finger and of the fourth actuated finger and vice versa;
a device for coupling the fourth actuation device with the second actuation device arranged so that the third actuation device is driven by the third actuator;
the coupling device comprises a first roller rotatably mounted on the first plate or the second plate about a ninth axis and which is driven by the second actuation device, a second roller rotatably mounted on the third plate or the fourth plate about a tenth axis and which drives the third actuation device, a movement transmission device transmitting a rotation from the first roller to the second roller;
the coupling device comprises an articulated arm comprising a first arm section and a second arm section articulated together about an eleventh axis, the first arm section being articulated about the ninth axis and the second arm section being articulated about the tenth axis, the articulated arm comprising a third idler roller of a transmission element of the transmission device.

Other features and advantages of the invention will appear upon reading the following description of a particular and non-limiting embodiment/implementation of the invention.

### BRIEF DESCRIPTION OF THE DRAWINGS

Reference will be made to the appended drawings, among which:

FIG. 1 is a planar schematic representation of a gripper according to a first embodiment of the invention;

FIG. 2 is a schematic representation of the gripper of FIG. 1 in a first clamping phase;

FIG. 3 is a schematic representation of the gripper of FIG. 1 in a second clamping phase;

FIG. 4 is a schematic representation of the gripper of FIG. 1 in a third clamping phase;

FIG. 5 is a planar schematic representation of a gripper according to a second embodiment of the invention in a clamping configuration;

FIG. 6 is a schematic representation of the gripper of FIG. 5 in a first planar gripping phase;

FIG. 7 is a schematic representation of the gripper of FIG. 5 in a second planar gripping phase;

FIG. 8 is a schematic representation of the gripper of FIG. 5 in a third planar gripping phase;

FIG. 9 is a schematic representation of the gripper of FIG. 5 in a fourth planar gripping phase;

FIG. 10 is a perspective schematic representation of a gripping device according to a third embodiment of the invention;

FIG. 11 is a partial perspective schematic representation of the embodiment of FIG. 10 according to a first view angle;

FIG. 12 is a partial perspective schematic representation of the embodiment of FIG. 10 according to a second view angle;

FIG. 13 is a partial schematic representation in bottom view of the embodiment of FIG. 10 in a retracted state;

FIG. 14 is a partial schematic representation in bottom view of the embodiment of FIG. 10 in a deployed state;

FIG. 15 is a partial schematic representation of a gripping device according to a fourth embodiment of the invention;

FIG. 16 is a partial schematic representation of a gripping device according to a fifth embodiment of the invention;

FIG. 17 is a schematic representation of a gripping device according to a sixth embodiment of the invention;

FIG. 18 is a partial perspective schematic representation of the embodiment of FIG. 17 according to a first view angle;

FIG. 19 is a partial schematic representation in bottom view of the embodiment of FIG. 17;

FIG. 20 is a partial perspective schematic representation of the embodiment of FIG. 17;

FIG. 21 is a refined partial schematic representation of FIG. 20;

FIG. 22 is a partial perspective schematic representation of different configurations of the gripper according to the embodiment of FIG. 17;

FIG. 23 is a partial perspective schematic representation of the different configurations of FIG. 22, the flanges having been represented;

FIG. 24 is a partial perspective schematic representation of the different configurations of the gripping device of the invention.

### DETAILED DESCRIPTION OF THE INVENTION

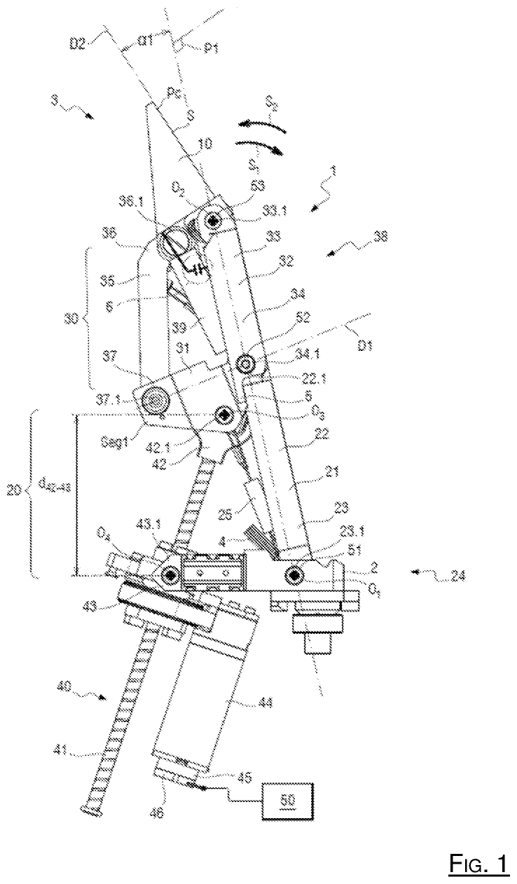

Referring to FIGS. 1 to 4, and according to a first embodiment, the gripper according to the invention, and generally designated 1, includes a frame 2 and an actuated finger 3. The finger 3 comprises a distal first phalanx 10 and proximal second phalanx 20 articulated on the frame 2 about a first axis O1. The phalanx 10 and the phalanx 20 are herein mechanically linked by a third phalanx 30 so as to enable a rotation of the phalanx 10 about a second axis O2 substantially parallel to the first axis O1.

The phalanx 20 comprises a first bar 21 including a first end 22 pivotally mounted at a first pivot point 22.1 to the phalanx 10 through a connecting rod 31 of the phalanx 30. The bar 21 also comprises a second end 23 articulated on the frame 2 about the axis O1 at a second pivot point 23.1. The phalanx 20 also comprises a first linear actuator—herein a cylinder 40 comprising a first nut/ball screw set 41—comprising a third end 42 pivotally linked at a third pivot point 42.1 to the connecting rod 31 and a fourth end 43 pivotally mounted on the frame 2 at a fourth pivot point 43.1. The cylinder 40 comprises a first gear-motor 44 provided with a first rotary encoder 45 and with a current sensor 46. The gear-motor 44, the encoder 45 and the sensor 46 are connected to a command and control unit 50.

As it appears in FIG. 1, the bar 21 and the cylinder 40 are arranged so as to form a first four-bar linkage 24 wherein a distance d42-43 separating the end 42 from the end 43 can be modified.

Thus, the first four-bar linkage 24 comprises the frame 2, the connecting rod 31, the bar 21 and the actuator 40 which acts as a last bar with a modifiable length of the four-bar linkage 24.

Each of the pivot points 42.1 and 43.1 herein linking the cylinder 40 respectively to the finger 3 and to the frame 2 achieve a sliding pivot type connection with a limited sliding respectively according to a third axis O3 and a fourth axis O4 substantially parallel to the first axis O1. Sliding according to the third axis O3 and the fourth axis O4 is said limited as the amplitude of sliding is limited by stops (not represented).

The phalanx 30 comprises a second bar 32 comprising a fifth end 33 articulated on the phalanx 10 at a fifth pivot point 33.1 and a sixth end 34 articulated on the connecting rod 31 at a sixth pivot point 34.1 coincident with the point 22.1. The phalanx 30 also comprises a third bar 35 comprising a seventh end 36 articulated at a seventh pivot point 36.1 on the phalanx 10 and an eighth end 37 articulated at an eighth pivot point 37.1 on the connecting rod 31. The connecting rod 31, the phalanx 10, the second bar 32 and the third bar 35 form a second four-bar linkage 38.

As shown in FIG. 1, an orthogonal projection of the third end 42 on a first line D1 connecting the first end 22 and the eighth end 37 belongs to a section Seg1 connecting the first end 22 and the eighth end 37.

The second phalanx 20 comprises a first tension spring 25 which extends between the point 23.1 and the point 42.1 so as to reduce the length of one of the diagonals of the four-bar linkage 24, namely the distance separating the point 23.1 from the point 42.1 towards the opening configuration.

The frame 2 comprises a stop 4 against which the bar 21 bears by the effect of the cylinder 40 when the latter commands an opening movement of the finger 3.

Thus, the stop 4 limits the amplitude of the rotation of the bar 21 about the axis O1 in a second way S2 opposite to the first way S1.

The third phalanx 30 comprises a second tension spring 39 which extends between the point 22.1 and the point 36.1 so as to reduce the length of one of the diagonals of the four-bar linkage 38, namely the distance separating the point 22.1 from the point 36.1.

The bar 32 comprises a stop 5 which projects from the end 34. The stop 5 bears against the bar 21 by the effect of the spring 25. Thus, the stop 5 limits the amplitude of the rotation of the bar 32 about the point 34.1 in the second way S2 towards the opening configuration.

The phalanx 10 comprises a stop 6 which bears against the bar 32 by the effect of the spring 39. Thus, the stop 6 limits the amplitude of the rotation of the phalanx 10 about the axis O2 in the second way S2.

The stop 6 herein blocks the rotation of the phalanx 10 about the axis O2 when the phalanx 10 is positioned so that an angle α1 measured between a first plane P1 comprising the axis O1 and the axis O2 and a second line D2 orthogonal to the axis O2 and which passes through a contact point Pc of the phalanx 10—in the case of a phalanx 10 having a planar contact surface S, the contact point is any point of the planar surface S—is equal to ten degrees.

Finally, the pivot points 22.1, 23.1, 33.1 respectively comprise a second rotary encoder 51, a third rotary encoder 52 and a fourth rotary encoder 53 connected to the unit 50.

The operation of the gripper 1 will be described when applied to clamping of an object 60 (herein cylindrical shaped) and with reference to FIGS. 1 to 4.

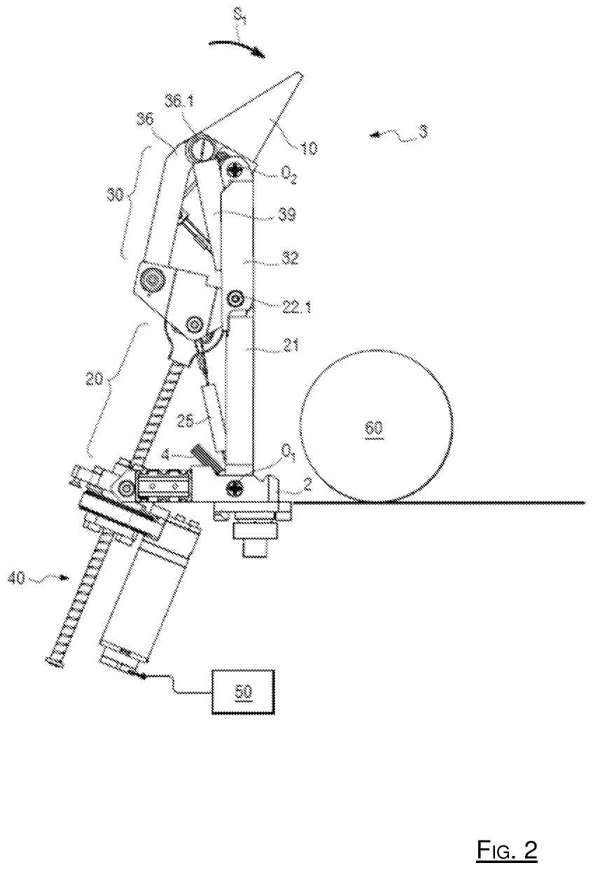

According to a first step, the unit 50 commands the cylinder 40 so as to make the finger 3 switch into an opening configuration represented in FIG. 1. For this purpose, depending on the pitch of the screw 41, the unit 50 can command a retraction of the screw 41. The finger 3 then adopts its opening configuration by the effect of the actuator 40 and of the springs 25 and 39 which respectively bring the bar 21, the bar 32 and the phalanx 10 in contact with the stops 4, 5 and 6. Once an object 60 is presented to the gripper 1, and according to a second step, the unit 50 commands the cylinder 40 so as to deploy the screw 41—i.e. so as to increase the distance separating the points 23.1 and 42.1. The finger 3 then performs a rotation about the first axis O1 in a first way S1. Under the action of the springs 25 and 39 which keep the bar 32 and the phalanx 10 respectively in contact with the stops 5 and 6, the rotation of the finger 3 consists of a rotation of the bar 21 about the axis O1, the other elements of the finger 3 remaining stationary relative to the bar 21. In particular, the phalanxes 10 and 30 are stationary relative to each other as well as relative to the bar 21. Once the bar 21 of the phalanx 20 comes into contact with the object 60, the deployment of the screw 41 causes a rotation of the phalanx 30 relative to the phalanx 20 about the point 22.1 (FIG. 2) in the way S1. Subjected to the action of the spring 39, the phalanx 10 is held against the stop 6 and remains stationary relative to the phalanx 30.

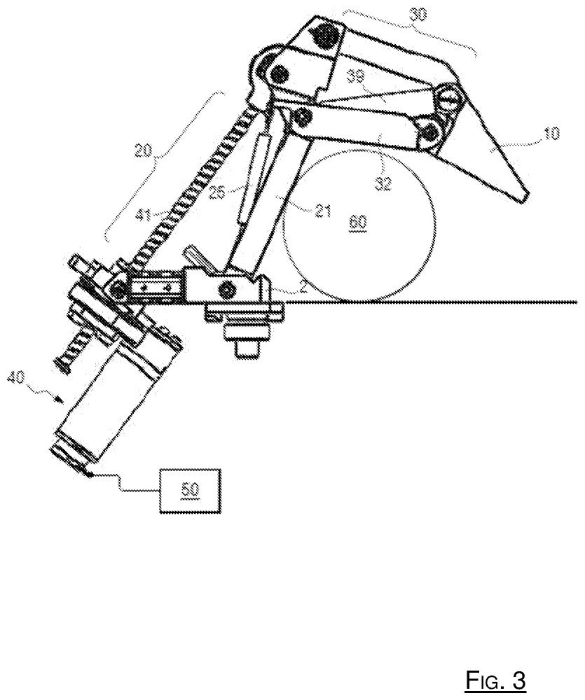

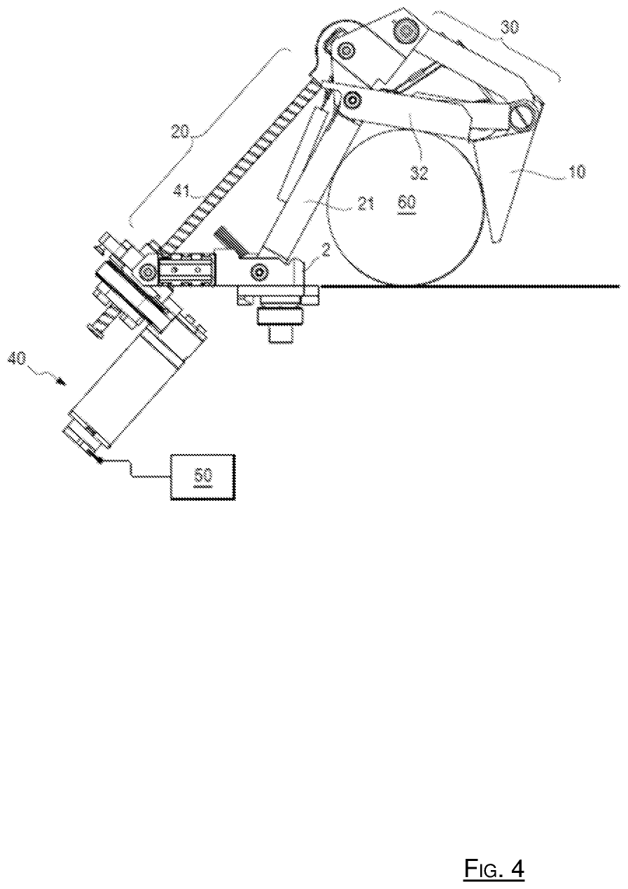

Carrying on the deployment of the screw 41 causes bringing the bar 32 of the phalanx 30 in contact with the object 60 (FIG. 3). According to a third step, the rotation of the phalanx 30 being blocked, the phalanx 10 starts a rotation in the way S1 about the axis O2 until coming into contact with the object 60 (FIG. 4).

On the basis of the information originating from the encoders 45, 51, 52 and 53 as well as from the current sensor 46, the control unit 50 determines the positions of the phalanxes 10, 20 and 30, the force applied at the end of the screw 41 and computes a clamping force applied by each of the phalanxes 10, 20, 30 of the finger 3 on the object 60. Thus, it is possible to define and control a maximum clamping force to be applied on the object 60.

Opening of the gripper 1 is done by commanding a retraction of the screw 41. Opening of the gripper 1 follows the reverse order of the clamping steps.

Elements that are identical or similar to those described before will bear a reference numeral identical thereto in the following description of two other embodiments of the invention.

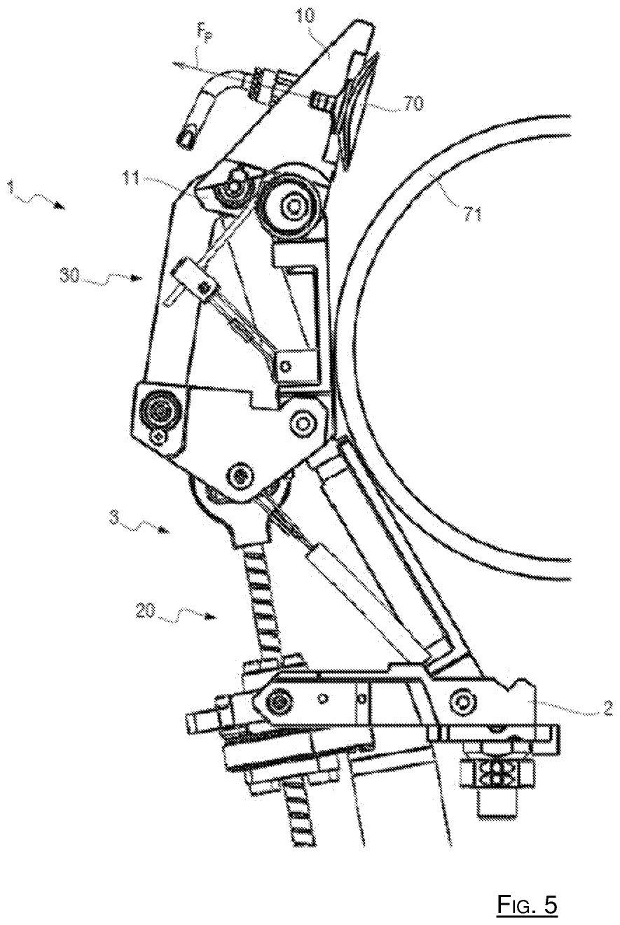

According to a second embodiment represented in FIGS. 5 to 7, the phalanx 10 comprises a pneumatic suction cup 70 arranged so as to exert a holding force Fp according to a direction substantially orthogonal to the first axis. The suction cup 70 is connected to a vacuum pump (not represented) connected to the unit 50.

The phalanx 10 herein comprises a stop 11 which cooperates with a surface 26 of the bar 32 to limit a first angular stroke C1 of a first rotation of the phalanx 10 about the axis O2 in the second way S2. The angular stroke C1 herein comprises a first angular sector Sa1 strictly positive according to the second way and measured starting from the plane P1. The angular sector Sa1 herein measures sixty degrees.

The finger 3 also comprises a third torsion spring 12 which extends around a shaft 13 for rotatably linking the phalanx 10 to the phalanx 30. The spring 12 comprises a wire 14 one end 14.1 of which is linked to the first end 15.1 of a cable 15. The second end 15.2 of the cable 15 is linked to the phalanx 20.

The length of the cable 15 is adjustable using a cable-clamp 16. The wire 14 bears against a surface 17 of the phalanx 10 so as to exert a third biasing force which brings the phalanx 10 from a position located in the first angular sector Sa1 into a position leading to the opening configuration of the finger 3 represented in FIG. 1. The length of the cable 15 allows adjusting the over-opening position of the phalanx 10 from which the third biasing force is exerted. In other words, the rigid stop 6 of the first embodiment is replaced by an elastic stop formed by the wire 14. The stop 11 is herein a first stop.

FIG. 5 illustrates a use of the gripper 1 according to the second embodiment for gripping a cylindrical object 71 a half-circumference of which is larger than a length of the finger 3.

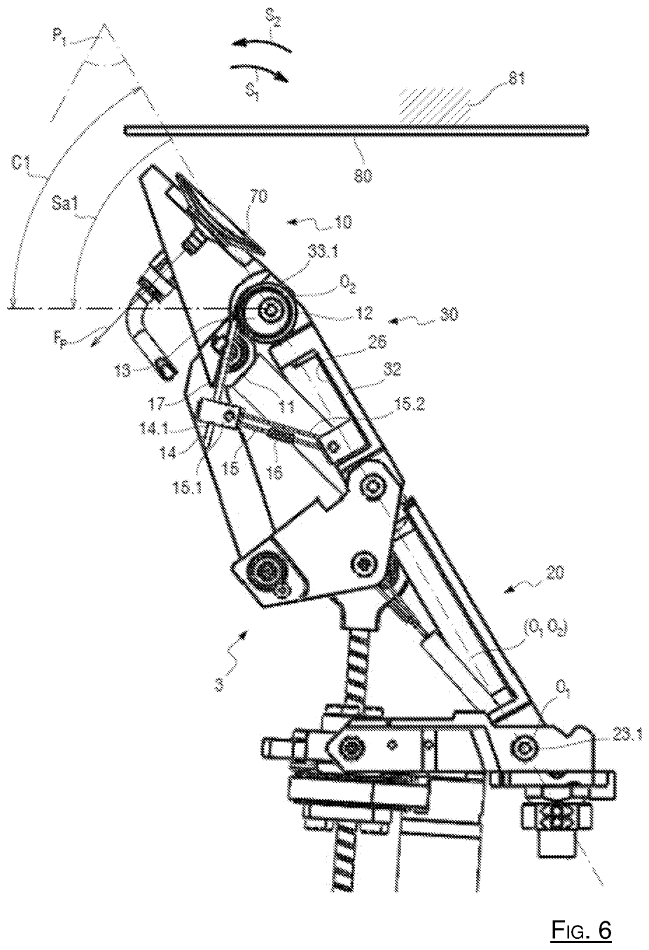

A particular use of the gripper 1 according to the second embodiment is described in connection with gripping of a second planar object 80 that rests on a support 81 and with reference to FIGS. 6 to 9.

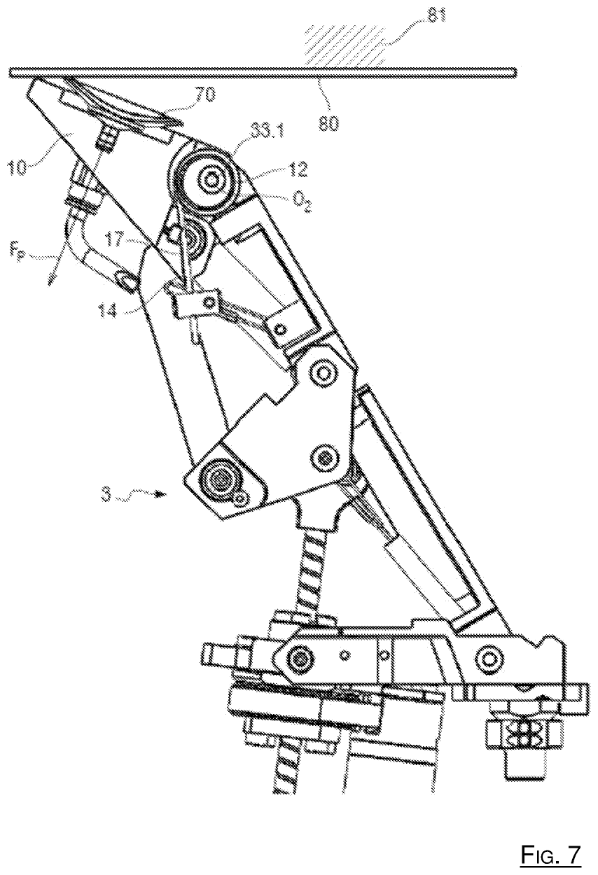

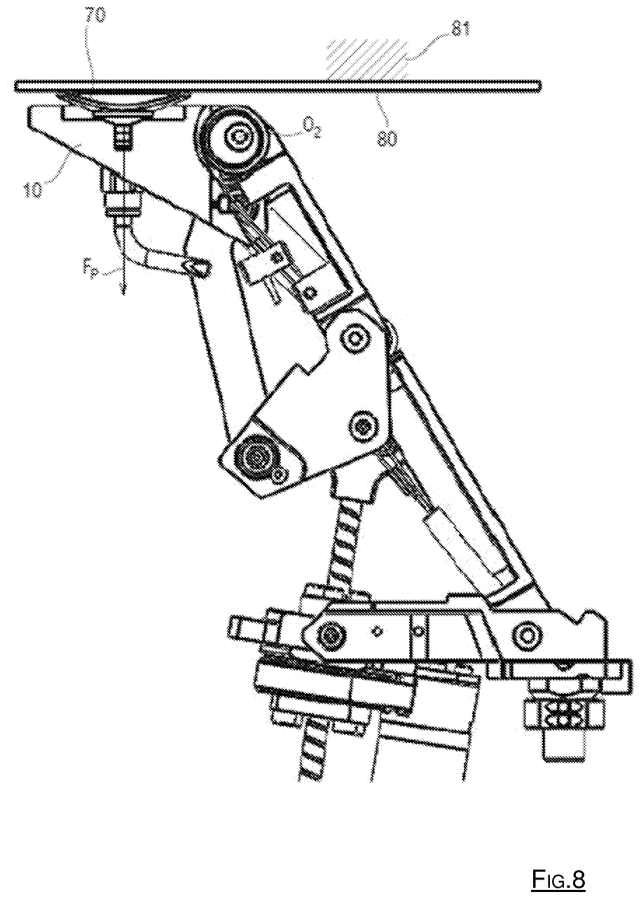

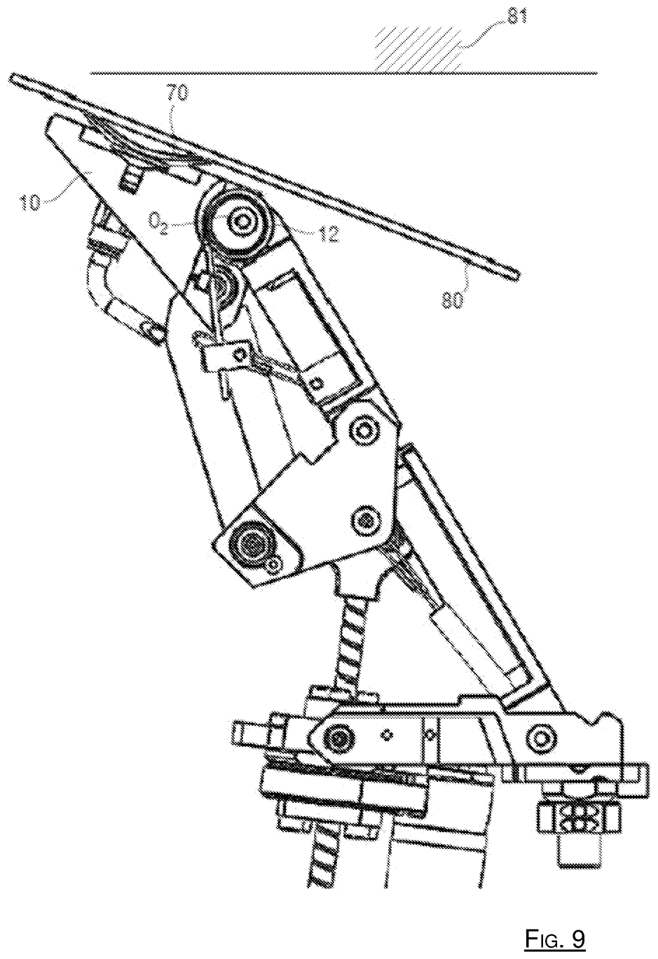

According to a first step, the finger 3 is placed in the opening configuration and the phalanx 10 is brought close to the object 80. One end of the phalanx 10 comes into contact with the object 80. According to a second step represented in FIG. 7, an approach of the gripper 1 to the object 80 is commanded which causes a rotation of the phalanx 10 about the point 33.1 according to the way S2. The surface 17 of the phalanx 10 then bears on the wire 14 and compresses the spring 12. According to a third step represented in FIG. 8, the approach movement of the gripper 1 is carried on until the phalanx 10 adopts a position in which the suction cup 70 is applied on the object 80. According to a third step, the unit 50 commands the suction cup 70 so that it exerts a holding force on the object 80. According to a fourth step represented in FIG. 9, a separation of the gripper 1 off the support 81 is commanded. The object 80 is kept secured to the phalanx 10 by the suction cup 70. As the gripper 1 is brought away from the support 81, the phalanx 10 performs a rotation about the axis O2 in the way S1 by the effect of the spring 12.

Such a gripper 1 allows grasping large-sized planar objects and objects with a smaller size by clamping.

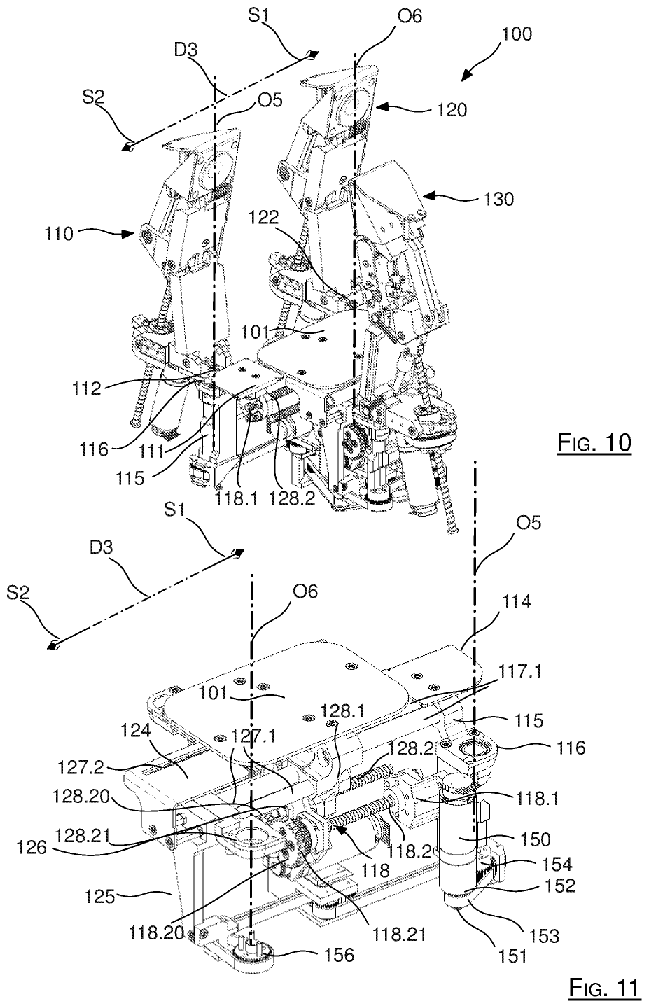

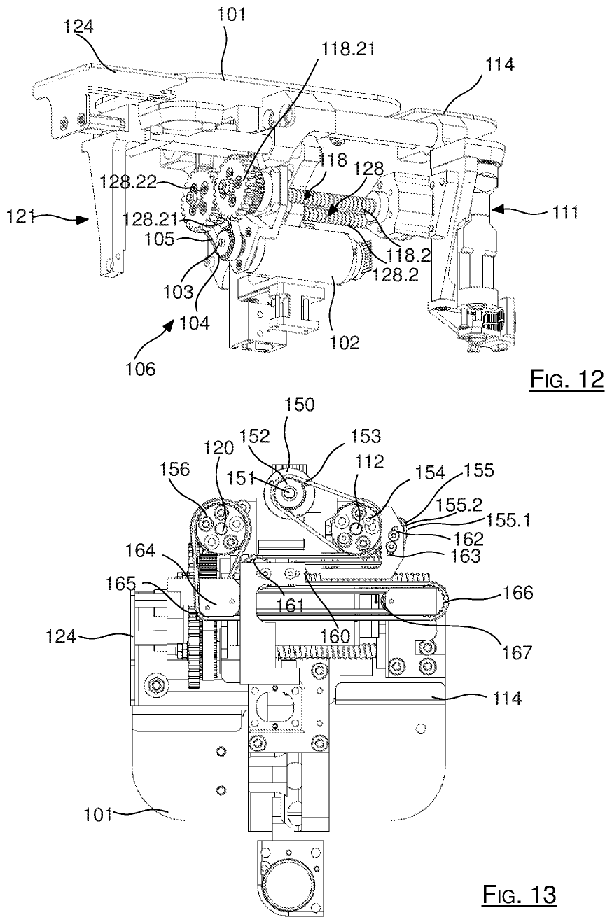

According to a third embodiment represented in FIGS. 10 to 14, a gripping device 100 comprises a first gripper 110, a second gripper 120 and a third gripper 130 whose respective fingers 113, 123 and 133 are linked to the same chassis 101. The first frame 112 of the gripper 110 and the second frame 122 of the gripper 120 are respectively carried by a first plate 111 and a second plate 121 slidably mounted according to a first direction D3 relative to the chassis 101. In turn, the third frame 131 of the third gripper 130 is fixedly mounted on the chassis 101.

The first plate 111 comprises a first platform 114 from which projects a first foot 115 provided with a first bracket 116 equipped with a non-represented journal which rotatably receives the frame 112 about a fifth axis O5, herein substantially vertical according to the representations of FIGS. 10 and 11. The first plate 111 also comprises, in a manner known per se, two first shafts 117.1 for guiding the translation of the plate 111 relative to the chassis 101. The plate 111 also comprises a second nut 118.1 of a second screw/nut set 118 whose second screw 118.2 is rotatably mounted relative to the chassis 101 and blocked in translation relative to the chassis 101. One end 118.20 of the screw 118.2 comprises a first gear wheel 118.21 for driving the screw 118.2.

Similarly, the second plate 121 comprises a second platform 124 from which projects a second foot 125 provided with a second bracket 126 equipped with a non-represented journal which rotatably receives the frame 122 about a sixth axis O6, herein substantially vertical according to the representations of FIGS. 10 and 11. The second plate 121 also comprises, in a manner known per se, two second shafts 127.1 and an aperture 127.2 for guiding the translation of the plate 121 relative to the chassis 101. The plate 121 also comprises a third nut 128.1 of a third screw/nut set 128 whose third screw 128.2 is rotatably mounted relative to the chassis 101 and blocked in translation relative to the chassis 101. One end 128.20 of the screw 128.2 comprises a first gear wheel 128.21 for driving the screw 128.2 as well as a second gear wheel 128.22 rotatably secured to the screw 128.2 and which meshes with the first gear wheel 118.21.

The chassis 101 also comprises a second electric gear-motor 102 whose output shaft 103 is provided with a first pinion 104 which collaborates with a first toothed belt 105. The toothed belt 105 rotatably links the first pinion 104 and the toothed wheel 128.21. Thus, a rotation of the pinion 104 in a first rotational way causes the rotation of the gear wheel 128.21—and therefore a rotation of the screw 128.2—in the same first rotational way. The gear train composed by the gear wheels 128.22 and 118.21 transmits the rotation of the screw 128.2 to the screw 118.2 in a second rotational way opposite to the first rotational way of the second screw 118.2. Preferably, the gear wheels 128.22 and 118.21 have an identical number of teeth.

Thus, the sliding movements of the first plate 111 and of the second plate 121 are actuated using a unique gear-motor 102 so that the first plate slides in a first way S1 of the direction D3 which is opposite to the second way S2 of sliding of the second plate 121.

The screw/nut sets 118 and 128, the gear wheel 118.21 and 128.22, the gear-motor 102, the pinion 104, the toothed wheel 128.21 and the belt 105 form a first actuation device 106.

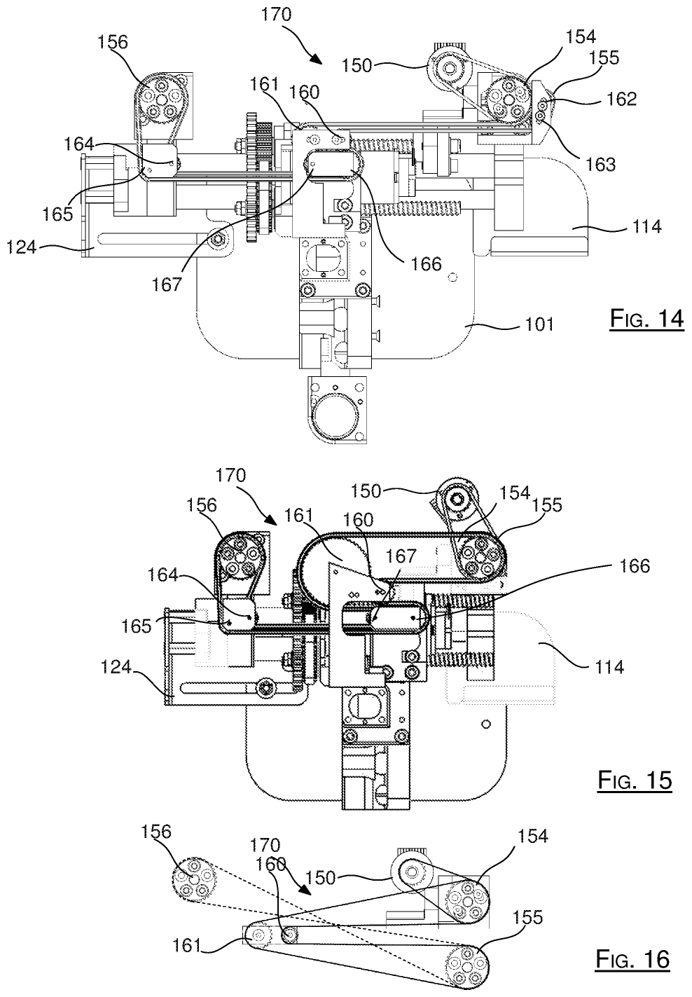

As shown in FIGS. 13 and 14, the rotation of the first finger 113 relative to the chassis 101 about the axis O5 and the rotation of the second finger 123 about the axis O6 are actuated using a unique third gear-motor 150 whose output 151 comprises a second toothed pinion 152 which drives a second toothed belt 153 which forms a closed loop. The gear-motor 150 is secured to the plate 111.

As shown in FIG. 14, the second toothed belt 153 cooperates with a second toothed wheel 154 rotatably secured to the frame 112 of the first gripper 110. The toothed wheel 154 also cooperates with a third toothed belt 155 over its external face 155.1 and over its internal face 155.2. The belt 155 also cooperates with a third toothed wheel 156 rotatably secured to the frame 122 of the second gripper 120.

The chassis 101 comprises a first idler 160 and a second idler 161 of the belt 155. The first idler 160 is herein a toothed idler rotatably mounted relative to the chassis 101 and which cooperates with the external face 155.1 of the belt 155. The second idler 161 is herein a toothed idler rotatably mounted relative to the chassis 101 and which cooperates with an internal face 155.2 of the belt 155.

Auxiliary idlers 162 and 163 linked to the first plate 111 press the external face 155.1 of the belt 155 on the toothed wheel 154 while collaborating respectively with the internal face 155.2 of the belt 155 and the external face 155.1 of the belt 155.

Additional auxiliary idlers 164 and 165 linked to the plate 121 press the internal face 155.2 of the belt 155 on the toothed wheel 156 while collaborating respectively with the external face 155.1 of the belt 155 and the internal face 155.2 of the belt 155. Finally, auxiliary idlers 166 and 167 also linked to the plate 121 press the belt on the idlers 160 and 161 while collaborating respectively with the external face 155.1 of the belt 155 and the internal face 155.2 of the belt 155. In particular, the idlers 162 to 167 contribute to a better compactness of the gripping device 100 and to an alignment of the grippers 110 and 120 on a line substantially parallel to the direction D1.

The gear-motor 150, the belt 155, the toothed wheels 154 and 156 as well as the idlers 160 to 167 form a second actuation device 170 arranged so that a sliding movement of the plate 111 and/or of the plate 121 is decoupled from a rotational movement of the first finger 113 and of the second finger 123 caused by activation of the gear-motor 150.

Conversely, a rotational movement of the first finger 113 and of the second finger 123 caused by activation of the gear-motor 150 is decoupled from a sliding movement of the plate 111 and/or of the plate 121. Indeed, the second actuation device 170 keeps a constant belt length 155 between the wheels 154 and 156. This arises in particular from the examination of FIGS. 14 and 15.

FIGS. 15 and 16 illustrate other configurations of the second actuation device 170 allowing obtaining the same effects of decoupling the rotational movements of the fingers 113 and 123 with the translational movements of the plates 111 and 121.

According to a fourth embodiment represented in FIG. 15, the actuation device 170 has no auxiliary idlers 162 and 163 and the toothed belt 155 is an internally-toothed belt. A non-represented known device for reversing the rotational way (for example a gear train) is interposed between the wheel 156 and the finger 123.

According to a fifth embodiment represented in FIG. 16, the actuation device 170 has no auxiliary idlers 162 to 167 and the toothed belt 155 is an internally-toothed belt. The reversal of the rotational way of the toothed wheel 156 with respect to the wheel 154 is carried out by crossing of the strands of an internally-toothed additional transmission belt 157.

Elements that are identical or similar to those described before for the fourth and fifth embodiments will bear a reference numeral identical thereto incremented by one hundred in the following description of a sixth embodiment of the invention.

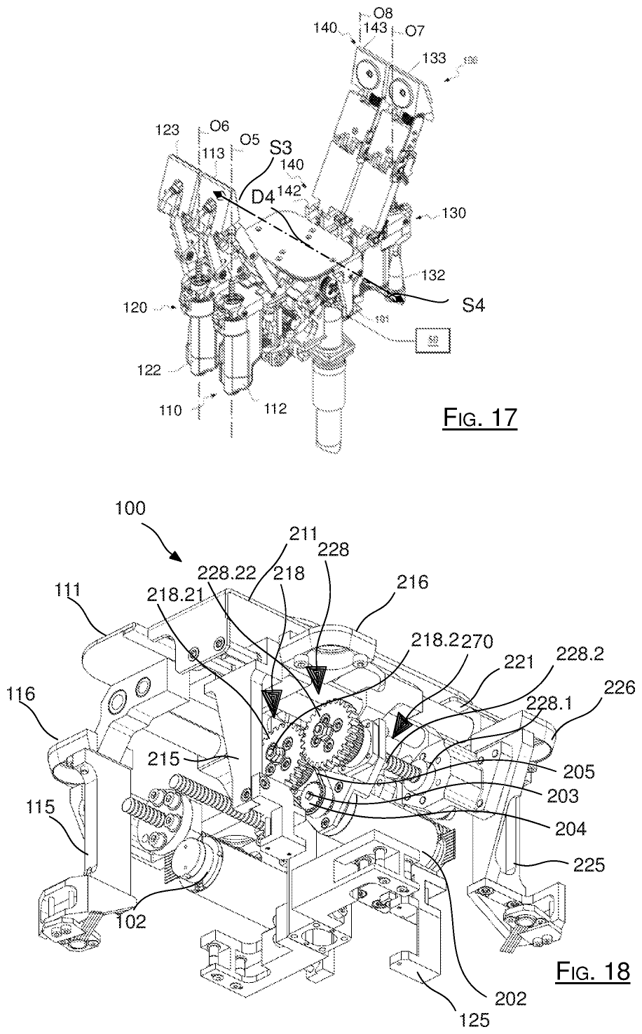

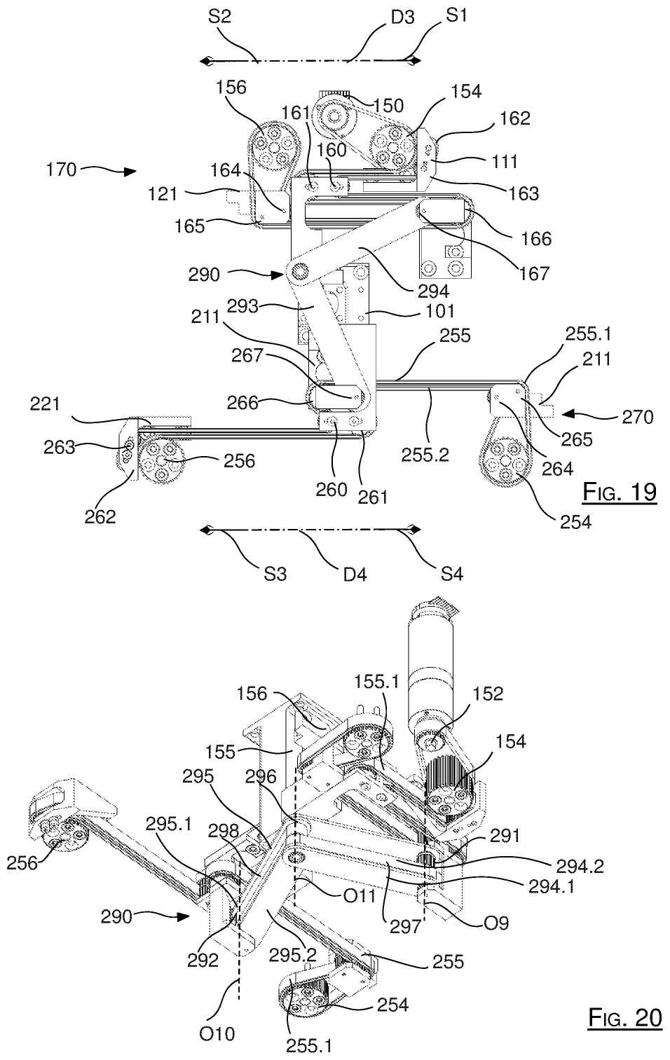

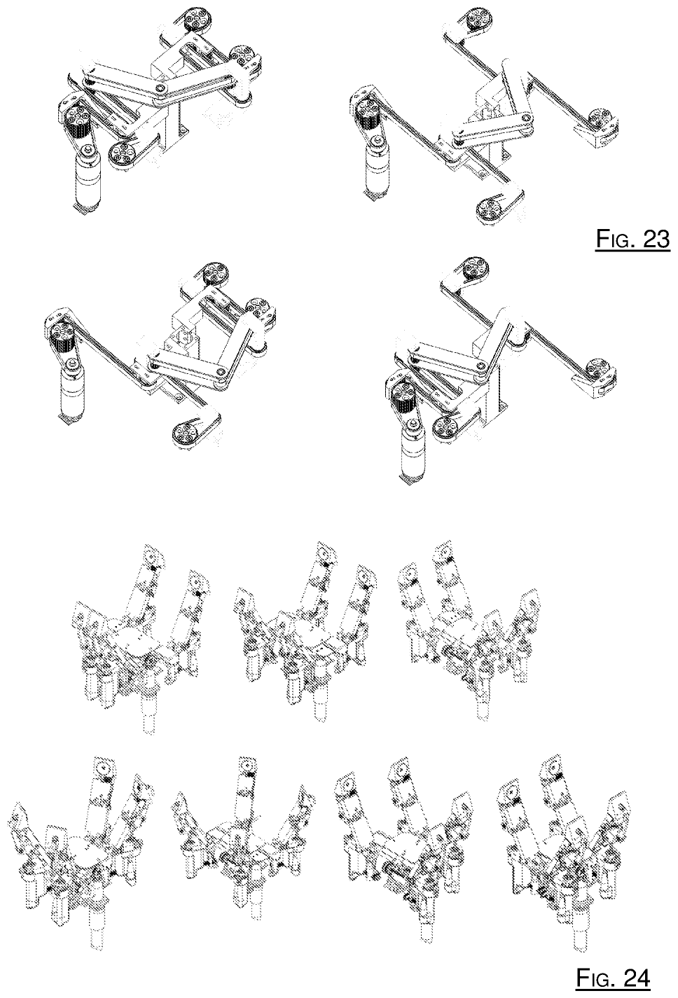

Referring to FIGS. 17 to 23, and according to the sixth embodiment, the gripping device 100 comprises a fourth gripper 140 provided with a fourth finger 143. The gripper 130 and the gripper 140 are respectively carried by a third plate 211 and a fourth plate 221 slidably mounted relative to the chassis 101 according to a second direction D4 substantially parallel to the direction D3. The frame 132 of the gripper 130 is rotatably received according to a vertical seventh axis O7 in a third bracket 216 of the third foot 215 of the plate 211. The frame 142 of the gripper 140 is rotatably received according to a vertical eighth axis O8 in a fourth bracket 226 of the fourth foot 225 of the plate 221.

The sliding movements of the plate 211 and of the plate 221 are actuated using a third actuation device 206 similar to the first actuation device 106 and which is provided with a unique fourth electric gear-motor 202. The output shaft 203 of the gear-motor 202 is provided with a third pinion 204 which collaborates with a fourth toothed belt 205. The toothed belt 205 drives a fourth screw 218.2 of a fourth screw/nut set 218 in rotation. The fourth screw 218.2 is linked to the chassis 101 and the fourth nut of the fourth screw/nut set 218 is secured to the plate 211. The rotation of the screw 218.2 is transmitted to a fifth screw 228.2 of a fifth screw/nut set 228. The screw 228.2 is linked to the chassis 101 and the fifth nut 228.1 of the screw/nut set 228 is secured to the plate 221. The transmission of the rotation of the fourth screw 218.2 to the fifth screw 228.2 is achieved using a gear comprising a third gear wheel 228.22 and a fourth gear wheel 228.21.

Thus, a rotation of the pinion 204 in a first rotational way causes a translation of the plate 211 in one way S3 of the direction D3 and a translation of the plate 221 in a way S4 opposite to the way S3.

Referring to FIG. 20, the rotation of the third finger 133 relative to the chassis 101 about the axis O7 and the rotation of the fourth finger 143 about the axis O8 are actuated using a fourth actuation device 270 identical to the actuation device 170 with the major exception that it has no gear-motor. Thus, the actuation device 270 comprises a fifth toothed belt 255 which forms a closed loop and which cooperates with a fourth toothed wheel 254 rotatably secured to the frame 132 of the third gripper 130. The belt 255 is toothed over its external face 255.1 and over its internal face 255.2. The belt 255 also cooperates with a fifth toothed wheel 256 rotatably secured to the frame 142 of the fourth gripper 140.

The chassis 101 also comprises a third idler 260 and a fourth idler 261 of the belt 255. The third idler 260 is herein a toothed idler rotatably mounted relative to the chassis 101 and which cooperates with the external face 255.1 of the belt 255. The fourth idler 261 is herein a toothed idler rotatably mounted relative to the chassis 101 and which cooperates with an internal face 255.2 of the belt 255.

Auxiliary idlers 264 and 265 linked to the third plate 211 press the internal face 255.2 of the belt 255 on the toothed wheel 254 while collaborating respectively with the external face 255.1 of the belt 255 and the internal face 255.2 of the belt 255.

Additional auxiliary idlers 262 and 263 linked to the plate 221 press the external face 255.1 of the belt 255 on the toothed wheel 256 while collaborating respectively with the internal face 255.2 of the belt 255 and the external face 255.1 of the belt 255. Finally, auxiliary idlers 266 and 267 also linked to the plate 211 press the belt on the idlers 260 and 261 while collaborating respectively with the internal face 255.2 of the belt 255 and the external face 255.1 of the belt 255. In particular, the idlers 262 to 267 contribute to a better compactness of the gripping device 100 and to an alignment of the grippers 130 and 140 on a line substantially parallel to the direction D4. Thus, the actuation device 270 is arranged so that a sliding movement of the third plate 211 and/or the fourth plate 221 is decoupled from a rotational movement of the third actuated finger 133 and of the fourth actuated finger 143. Conversely, a rotational movement of the third actuated finger 133 and of the fourth actuated finger 143 is decoupled from a sliding movement of the third plate 211 and/or of the fourth plate 221.

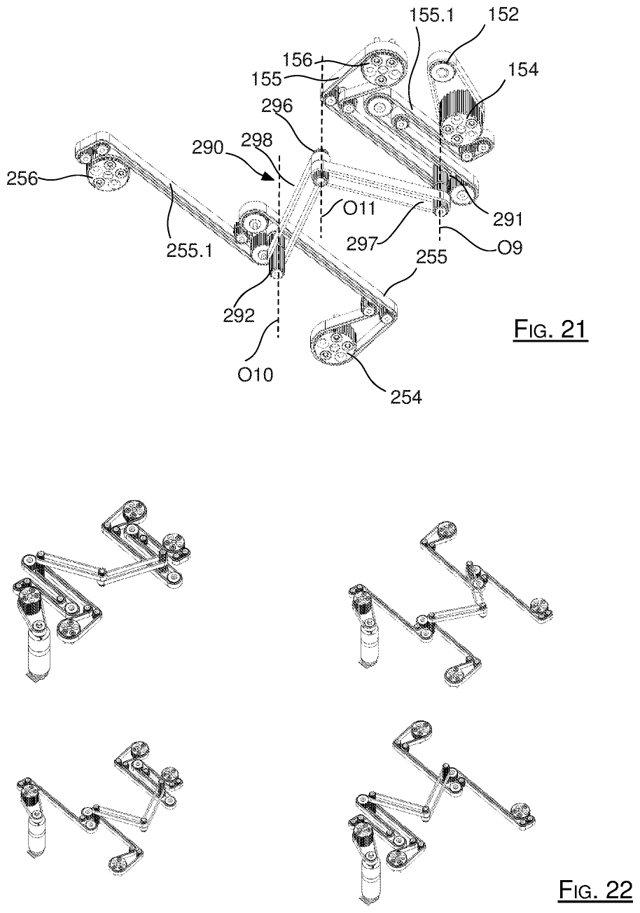

As shown in FIGS. 21 and 22, a coupling device 290 links the second actuation device 170 with the fourth actuation device 270 so that the fourth actuation device 270 is driven by the gear-motor 150.

To this end, the coupling device 290 comprises a first toothed roller 291 rotatably mounted on the second plate 121 about a substantially vertical ninth axis O9 and which collaborates with the external face 155.1 of the belt 155 so as to be driven by the latter.

More specifically, the first toothed roller 291 is rotatably secured to the idler 167 which, in turn, is driven in rotation by the belt 155 external face 155.1. The coupling device 290 also comprises a second toothed roller 292 rotatably mounted on the third plate 211 about a vertical tenth axis O10 and which collaborates with the external face 255.1 of the belt 255 so as to drive the latter. More specifically, the second toothed roller 292 is rotatably secured to the idler 267 which collaborates with the external face 255.1 of the belt 255.

The coupling device 290 also comprises an articulated arm 293 comprising a first arm section 294 and a second arm section 295 articulated together about an eleventh axis O11. A third toothed roller 296 is rotatably mounted about the axis O11. The first section 294 comprises two flanges 294.1 and 294.2 which extend parallel to each other so as to connect the axis O11 and the axis O9 about which they are articulated. The second section 295 comprises two flanges 295.1 and 295.2 which extend parallel to each other so as to connect the axis O11 and the axis O10 about which they are articulated. A sixth toothed belt 297 extends between the roller 291 and the roller 296. A seventh toothed belt 298 extends between the roller 296 and the roller 292. The roller 296, the belts 297 and 298 as well as the flanges 295.1 and 295.2 form a movement transmission device 299 transmitting a rotation of the first roller 291 to the second roller 292.

Thus, the coupling device 290 transmits a rotation of the first roller 291 caused by the gear-motor 150 to the second roller 292 which thus actuates the rotation of the wheels 254 and 256, causing a rotation of the fingers 133 and 143 in opposite ways. The three articulation points of the arm 293 as well as the roller 296 allow keeping coupling of the two actuation devices 170 and 270 irrespective of the relative positions thereof, while keeping a decoupling between the translational and rotational movements of the fingers 113, 123, 133 and 143.

The relative arrangement of the fingers 113, 123, 133 and 143 relative to the frame can then adopt a plurality of configurations represented in FIG. 24 which confers a great versatility on the device 100.

Of course, the invention is not limited to the described embodiment but encompasses any variant falling within the scope of the invention as defined by the claims.

In particular,
although herein the gripper comprises a unique finger, the invention also applies to a gripper comprising one finger and one fixed obstacle;
although herein the gripping device comprises four grippers, the invention also applies to a gripping device comprising a different number of grippers such as two grippers, three grippers or more than four;
although herein the gripping device comprises four grippers whose fingers are linked to the same frame, the invention also applies to a gripping device wherein the frames of the different grippers are rigidly linked or articulated together;
although herein the first and second phalanxes are linked by a third phalanx, the invention also applies to a finger comprising a different number of phalanxes such as one finger comprising a first phalanx mechanically linked directly to a second phalanx, or a first phalanx linked to the second phalanx through more than one phalanx, such as two or three additional phalanxes;
although herein the second phalanx comprises a first spring, the invention also applies to other types of first member for biasing the finger towards the opening configuration such as a magnet, a counterweight or an elastic element other than a spring such as a stack of Belleville-type elastic washers, an elastomeric block and possibly a gas spring;
although herein the third phalanx comprises a second spring, the invention also applies to other types of second member for biasing the finger towards the opening configuration such as a magnet, a counterweight or an elastic element other than a spring such as a stack of Belleville-type elastic washers, an elastomeric block and possibly a gas spring;
although herein the first phalanx comprises a third spring, the invention also applies to other types of third member for biasing the phalanx towards the opening configuration such as a magnet, a counterweight or an elastic element other than a spring such as a stack of Belleville-type elastic washers, an elastomeric block and possibly a gas spring;
although herein the springs used in the second and third phalanxes are tension springs installed along the diagonal of the four-bar linkage which is stretched during the movement of the finger in the first closure way, the invention applies if the springs were compression springs installed along a second diagonal of the four-bar linkage which is compressed during the movement of the finger in a first closure way, or if the springs are torsion springs mounted between two adjacent sides of a four-bar linkage so as to store elastic energy during the movement of the finger in a first closure way;
although herein the biasing members in the second and third phalanxes are tension springs and the opening configuration of the gripper is defined by the mechanical balance respectively of the bar 21, the bar 32 and the phalanx 10 in contact with the stops 4, 5 and 6 by the action of said biasing members and of the actuator 40, the invention also applies to a gripper comprising double-acting biasing members—tension and compression around a zero-action central position—in the second and third phalanxes, comprising no stops 4, 5, 6, and where the opening configuration is defined by a controlled extension length of the actuator and the central positions of the double-acting biasing members
although herein the finger comprises three rotary encoders for measuring the rotations of the phalanxes, the invention also applies to a gripper comprising a different number of rotary encoders such as two encoders for three articulations—and more generally one encoder lesser than the number of phalanxes, the angular position of the last articulation may be deduced from the data of the other encoders and from the measurement of the angular position of the motor which allows computing the extension of the ball screw;
although herein the suction cup is positioned on the first phalanx, the invention also applies to other setups of the suction cup on the finger, such as a suction cup secured to the second or third phalanx;
although herein the gripper comprises a pneumatic suction cup, the invention also applies to other types of controllable adhesive elements such as a mechanical, magnetic suction cup, an adhesive member by electrostatic effect, by Van der Walls type dry adhesion, or a pressure-sensitive adhesive similar to those of sticky notes;
although herein the angular sector measures sixty degrees, the invention also applies to other values of the angular sector such as an angular sector comprised between ten and ninety degrees, preferably comprised between twenty and sixty degrees;
although herein the fingers are rotatably mounted about a vertical axis, the invention also applies to other orientations of the axis of rotation of the finger relative to the frame, such as a random orientation and preferably orthogonal and/or secant to the first axis;
although herein the fingers are fitted with a rotational movement and with a translational movement relative to the frame, the invention also applies if the connection comprised two axes of rotation enabling a rotation perpendicular to the palm and adduction/abduction movements of the fingers, or any other architecture for moving the fingers relative to the palm
although herein the third phalanx has a four-bar linkage type structure, the invention also applies to other types of movement transmission structures such as a gear train or a pulleys/belts set;
although herein the grippers have been represented mounted on the chassis according to vertical axes, the invention also applies to other orientations of the axes of rotation of the grippers, preferably and in particular axes substantially orthogonal to the first axis O1;
although herein, the gripping device comprises a first screw/nut set and a second screw/nut set, the invention also applies to other types of first actuation device such as a device comprising two distinct actuators for each plate, hydraulic or electric cylinders, a unique cylinder and a cable-and-pulley transmission;
although herein the first pinion cooperates with a toothed belt, the invention also applies to other types of first member for transmitting a drive force such as a smooth belt, whether flat or not, a chain or a gear train. This is also valid for all toothed belts of the invention that can advantageously be replaced by cables, chains, smooth belts or a gear train;
although herein the actuation devices comprise an electric gear-motor, the invention also applies to other actuator types such as an electric or hydraulic cylinder, a stepper motor;
although herein the first gear-motor is secured to the first plate, the invention also applies to a gear-motor secured to the second plate;
although herein the rollers are toothed so as to convey a toothed belt, the invention also applies to other types of idler rollers such as gear wheels in the case of a transmission element that would be a chain;
although herein, each plate comprises a screw/nut set, the invention also applies to other actuator types, including a transmission between the plates that would comprise a cable and an idler pulley;
although herein the gripping device has been described in connection with grippers provided with under-actuated fingers according to the invention, the invention also applies to a gripping device implementing other known types of grippers provided with fingers such as a gripper provided with fingers all phalanxes of which are actuated.

1. A gripper comprising a frame and an actuated finger, the finger comprising a first distal phalanx and a second proximal phalanx which is articulated on the frame about a first axis, the first phalanx and the second phalanx being mechanically linked so as to enable a rotation of the first phalanx about a second axis substantially parallel to the first axis so that the finger could switch from an opening configuration into a clamping configuration when the first phalanx and/or the second phalanx performs a rotation in a first way relative to the frame, wherein:
the second phalanx comprises a first bar comprising a first end linked to the first phalanx and a second end pivotally mounted on the frame about the first axis, and
the second phalanx also comprises a linear actuator comprising a third end linked to the first phalanx and a fourth end pivotally mounted on the frame, the first bar and the linear actuator being arranged so as to form a first four-bar linkage wherein a distance separating the third end from the fourth end can be modified.

2. The gripper according to claim 1, wherein the finger comprises a third phalanx linking the first phalanx and the second phalanx.

3. The gripper according to claim 2, wherein the third phalanx comprises a second bar comprising a fifth end articulated on the first phalanx and a sixth end articulated on a first connecting rod, the third phalanx also comprising a third bar comprising a seventh end articulated on the first phalanx and an eighth end articulated on the first connecting rod, the first end and the third end being articulated with the first connecting rod.

4. The gripper according to claim 3, wherein an orthogonal projection of the third end on a line connecting the first end and the eighth end belongs to a section connecting the first end and the eighth end.

5. The gripper according to claim 4, wherein the first end is articulated on the sixth end.

6. The gripper according to claim 1, wherein the second phalanx comprises a first means for biasing the finger towards the opening configuration.

7. The gripper according to claim 6, wherein the first biasing member comprises an elastic element.

8. The gripper according to claim 2, wherein the third phalanx comprises a second biasing member the finger towards the opening configuration.

9. The gripper according to claim 1, comprising a first stop for limiting a first angular stroke of a first rotation of the first phalanx about the second axis in a second way opposite to the first way.

10. A gripping device comprising a chassis on which a plurality of grippers are mounted, the plurality of grippers comprising a first gripper, a second gripper and a third gripper.

11. The gripping device according to claim 10, wherein the first gripper and the second gripper are respectively carried by a first plate and a second plate slidably mounted relative to the chassis according to two opposite ways of a first direction, and wherein the sliding movements of the first plate and of the second plate are actuated using a first actuation device provided with a unique second actuator.

12. The gripping device according to claim 10, wherein:
the first gripper comprising a first actuated finger, the second gripper comprising a second actuated finger, the first actuated finger is articulated relative to the first plate about a fifth axis and the second actuated finger is articulated relative to the second plate about a sixth axis the fifth axis and the sixth axis being substantially orthogonal to the first axis, and wherein, a rotation of the first finger relative to the first plate about the fifth axis and a rotation of the second finger relative to the second plate about the sixth axis are actuated using a second actuation device provided with a unique third actuator.

13. The gripping device according to claim 12, wherein the second actuation device is arranged so that a sliding movement of the first plate and/or of the second plate is decoupled from a rotational movement of the first actuated finger and of the second actuated finger and vice versa.

14. The gripping device according to claim 12, wherein the second actuation device is arranged so that the rotational movements of the first finger and of the second finger are performed in opposite rotational ways.

15. The gripping device according to claim 10, wherein the plurality of grippers comprises a fourth gripper,
the third gripper and the fourth gripper being respectively carried by a third plate and a fourth plate slidably mounted relative to the chassis according to two opposite ways of a second direction, the sliding movements of the third plate and of the fourth plate being actuated using a third actuation device provided with a unique fourth actuator.

16. The gripping device according to claim 15, wherein the third gripper comprising a third actuated finger and the fourth gripper comprising a fourth actuated finger, the third actuated finger is articulated relative to the third plate about a seventh axis and the fourth actuated finger is articulated relative to the fourth plate about an eighth axis, the seventh axis and the eighth axis being substantially orthogonal to the first axis, and wherein a rotation of the third finger relative to the third plate about the seventh axis and a rotation of the fourth finger relative to the fourth plate about the eighth axis are actuated using a fourth actuation device arranged so that the rotational movements of the third finger and of the fourth finger being performed in opposite rotational ways.

17. The gripping device according to claim 16, wherein the fourth actuation device is arranged so that a sliding movement of the third plate and/or the fourth plate is decoupled from a rotational movement of the third actuated finger and of the fourth actuated finger and vice versa.

18. The gripping device according to claim 12, comprising a device for coupling the fourth actuation device with the second actuation device arranged so that the fourth actuation device is driven by the third actuator.

19. The gripping device according to claim 18, wherein the coupling device comprises a first roller rotatably mounted on the first plate or the second plate about a ninth axis and which is driven by the second actuation device, a second roller rotatably mounted on the third plate or the fourth plate about a tenth axis and which drives the third actuation device, a movement transmission device transmitting a rotation from the first roller to the second roller.

20. The gripping device according to claim 19, wherein the coupling device comprises an articulated arm comprising a first arm section and a second arm section articulated together about an eleventh axis, the first arm section being articulated about the ninth axis and the second arm section being articulated about the tenth axis, the articulated arm comprising a third idler roller of a transmission element of the transmission device.
